(19) United States
(12) Patent Application Publication
(10) Pub. No.: US 2025/0250846 A1
(43) Pub. Date: Aug. 7, 2025

(54) METHOD FOR OPERATING A MOTORIZED CLOSURE ELEMENT ASSEMBLY OF A MOTOR VEHICLE

(71) Applicant: Brose Fahrzeugteile SE & Co. Kommanditgesellschaft, Bamberg, Bamberg (DE)

(72) Inventors: Fabian Engler, Bamberg (DE); Sebastian Rauh, Ebensfeld (DE)

(21) Appl. No.: 19/038,045

(22) Filed: Jan. 27, 2025

(30) Foreign Application Priority Data
Feb. 6, 2024 (DE) 10 2024 103 273.1

(51) Int. Cl. E05F 15/76

(52) U.S. Cl. CPC E05F 15/76; E05Y 2400/852; E05Y 2400/858; E05Y 2900/546

(57) ABSTRACT

A method for operating a motorized closure element assembly of a vehicle having a closure element, using a sensor system having a plurality of UWB modules that have a module controller, wherein the UWB modules are to carry out a localization of an operator approaching the motor vehicle, wherein the module controllers operate a first antenna of the UWB module with a first directional characteristic, wherein, on detection of a predefined switching event related to the operator, a gesture recognition is performed by the UWB modules, wherein the module controllers operate a second antenna of the UWB module with a second directional characteristic having a main direction for sending and receiving UWB radar signals, wherein the presence of a predefined operator gesture in the region of interest is monitored using the UWB radar signals and, upon a valid operator gesture, activation of the motorized closure element assembly is initiated.

### CLAIM OF PRIORITY

This application claims the benefit of German Patent application No. DE 10 2024 103 273.1 filed on Feb. 6, 2024, the disclosure of which is incorporated herein by reference.

### FIELD OF THE TECHNOLOGY

Various embodiments relate to a method for operating a motorized closure element assembly of a motor vehicle, a sensor system for a motorized closure element assembly of a motor vehicle and to a closure element assembly for a motor vehicle.

### BACKGROUND

The known prior art (DE 10 2021 106 552 A1), which various embodiments take as their starting point, relates to a sensor system with distance sensors which can be designed as radar sensors which serve to detect an operator of the motor vehicle. The motorized adjustment is triggered by an operator gesture, which allows the operator to open or close the closure element without contact. For example, the operator gesture is a predefined foot movement of the operator.

### SUMMARY

On the one hand, it is a challenge to improve the detection of the operator in order to achieve the likelihood of detecting the operator's gesture while suppressing possible false alarms. On the other hand, it is desirable to integrate the radar-based detection of the operator into a vehicle access functionality such as Phone as a Key (Paak) with as little effort as possible.

The object addressed by some embodiments is to configure and refine the known method in such a way that further optimization is achieved with regard to the aforementioned challenge.

This object is achieved by various features described herein.

The motorized closure element assembly in question is designed for adjusting a closure element of the motor vehicle by means of an electric drive. The term “closure element” is to be understood in a broad sense and includes, for example, a tailgate, a trunk lid, an engine hood, a side door, a luggage compartment door, a window pane, a sunroof, or the like. The closure element may be arranged so as to be pivotable and/or longitudinally displaceable on the motor vehicle body.

The fundamental consideration is that the operator is detected using ultra-wideband (UWB) technology. UWB modules are used here both for localizing the operator when approaching the vehicle and for capturing the operator gesture. However, in order to achieve improved performance for detecting the operator gesture, the UWB modules each have at least one first antenna and second antenna, which are designed with different directional characteristics.

By means of the UWB modules, the operator approaching the motor vehicle is located via the respective first antenna of the UWB module with a first directional characteristic. Upon detection of a predefined switching event related to the operator, the UWB modules are used to perform a gesture recognition in which the respective second antenna of the UWB module is used. The main directions of the second directional characteristics are directed at a predefined region of interest for executing the operator gesture, so that an improved detection of the operator gesture is achieved regardless of the localization requirements. Because the UWB modules are each equipped with a first antenna and a second antenna, which are jointly controlled by the respective module controller, only a small amount of additional construction effort is required.

It can be provided to use an omni-directional characteristic such as a spherical characteristic for the localization and to use a directed directional characteristic such as a lobe characteristic for the gesture recognition, which is the subject matter of various embodiments.

Various configurations of the antennas and the structure of the UWB modules are specified in some embodiments.

The orientations of the main directions of the second antennas according to various embodiments are used to bring about an improved detection of the operator gesture by a largely overlapping detection range of the UWB modules in the region of interest.

The first and second antennas can also be used for different operating modes of the UWB modules. In various embodiments, in contrast to the radar-based gesture recognition for localization, a UWB communication with a mobile device of the operator is provided. The operating modes can be optimally utilized by way of the configuration of the antennas.

Further embodiments of the detection of the operator as part of a vehicle access functionality are provided.

The proposed method can be advantageously extended to motor vehicles having a plurality of motorized closure element assemblies. In this case, respective UWB modules can be assigned to the closure element assemblies and the gesture recognition can be performed selectively for the respective closure element.

According to various embodiments, a sensor system for a motorized closure element assembly of a motor vehicle is proposed. The sensor system is equipped with a plurality of UWB modules, which are designed for localizing an operator approaching the motor vehicle by means of a first antenna. Gesture recognition is provided by means of a second antenna of the UWB module. The sensor system can be used to implement the proposed method. Reference may therefore be made in this respect to all the comments in relation to the proposed method.

According to various embodiments, a closure element assembly for a motor vehicle is provided. The closure element assembly comprises a closure element, a drive assembly assigned to the closure element having at least one drive for the motorized adjustment of the closure element, and a sensor system having a plurality of UWB modules. The closure element assembly is configured to carry out the proposed method. Reference may therefore be made to all the comments in relation to the proposed method and the proposed sensor system.

Various embodiments provide a method for operating a motorized closure element assembly of a motor vehicle having a closure element, using a sensor system having a plurality of UWB modules which are arranged spaced apart from each other on the motor vehicle and have a module controller in each case, wherein the UWB modules are used to carry out a localization of an operator approaching the motor vehicle, in which the module controllers operate a respective first antenna of the UWB module with a first directional characteristic for sending and receiving UWB signals, wherein, on detection of a predefined switching event related to the operator, a gesture recognition is performed by means of the UWB modules, in which the module controllers operate a respective second antenna of the UWB module with a second directional characteristic having a main direction for sending and receiving UWB radar signals, wherein the main directions are directed at a predefined region of interest for executing the operator gesture, wherein in the gesture recognition, the execution of an operator gesture in the region of interest is monitored using the UWB radar signals and, in the presence of a valid operator gesture, activation of the motorized closure element assembly to adjust the closure element is initiated.

In various embodiments, the first antennas each have an omnidirectional first directional characteristic, and/or in that the second antennas each have a lobe characteristic, a bidirectional characteristic and/or cardioid characteristic as the second directional characteristic.

In various embodiments the first antenna is designed as a patch antenna and/or the second antenna is designed as an Edgefire antenna, in particular Vivaldi antenna. In some embodiments, the first antenna and second antenna are arranged on a common printed circuit board of the respective UWB module. In some embodiments, the module controller is also arranged on the printed circuit board.

In various embodiments, the module controller, the first antenna and the second antenna are arranged in a common module housing of the respective UWB module.

In various embodiments, the main directions of the second antennas are directed toward one another. In various embodiments, the main directions of the second antennas intersect in the predetermined region of interest. In various embodiments, the region of interest is predefined in front of the closure element, in particular on a control element of the closure element and/or on a fender on the closure element assembly.

In various embodiments, the localization is performed via a UWB communication between at least one of the UWB modules and a mobile device assigned to the operator. In various embodiments, the localization is triggered on detection of the mobile device via a further wireless communication, in particular BLE communication. Further, in some embodiments, the UWB communication and/or the BLE communication is used to perform authentication of the mobile device.

In various embodiments, in response to an approach of the operator being detected in the localization, the closure element assembly is unlocked. In some embodiments, the approach of the operator is deemed to be detected if the localization results in a distance that is less than a predefined first distance between the mobile device and the motor vehicle.

In various embodiments, the switching event is deemed to be detected if the localization results in a distance that is less than a predetermined second distance between the mobile device and the closure element assembly and/or a predefined approach trajectory to the closure element assembly being maintained.

In various embodiments, if a valid operator gesture fails to be detected in the gesture recognition, the procedure reverts back to localization of the operator by means of the UWB modules.

In various embodiments, the sensor system comprises a plurality of pairs of UWB modules, which are each assigned to one of a plurality of motorized closure element assemblies of the motor vehicle and for each of which a switching event is predefined, and that gesture recognition is performed on detection of one of the switching events by means of the respectively assigned pair of UWB modules.

Various embodiments provide a sensor system for a motorized closure element assembly of a motor vehicle, wherein the sensor system is equipped with a plurality of UWB modules which are arranged spaced apart from each other on the motor vehicle and have a module controller in each case, wherein the UWB modules are designed for localization of an operator approaching the motor vehicle, in which the module controllers operate a respective first antenna of the UWB module with a first directional characteristic for sending and receiving UWB signals, wherein on detection of a predefined switching event related to the operator, the UWB modules perform a gesture recognition in which the module controllers operate a respective second antenna of the UWB module with a second directional characteristic having a main direction for sending and receiving UWB radar signals, wherein in the assembled state of the sensor system the main directions are directed at a predefined region of interest for executing the operator gesture.

In various embodiments, the sensor system has a control assembly, which monitors the execution of an operator gesture in the region of interest in the gesture recognition based on the UWB radar signals and, in the presence of a valid operator gesture, initiates the activation of the motorized closure element assembly.

Various embodiments provide a closure element assembly for a motor vehicle, the closure element assembly comprising a closure element, a drive assembly associated with the closure element having at least one drive for the motorized adjustment of the closure element, and a sensor system having a plurality of UWB modules, wherein the closure element assembly is designed for carrying out the method as described herein.

### BRIEF DESCRIPTION OF THE DRAWINGS

Hereafter various aspects will be described in more detail by reference to a drawing showing exemplary embodiments. In the drawing,

FIG. 1 shows a perspective view of a rear section of a motor vehicle having a closure element assembly for carrying out the proposed method with a proposed sensor system and

FIG. 2 shows the motor vehicle from FIG. 1 in a plan view, a) during a localization procedure and b) during a gesture recognition procedure.

### DETAILED DESCRIPTION

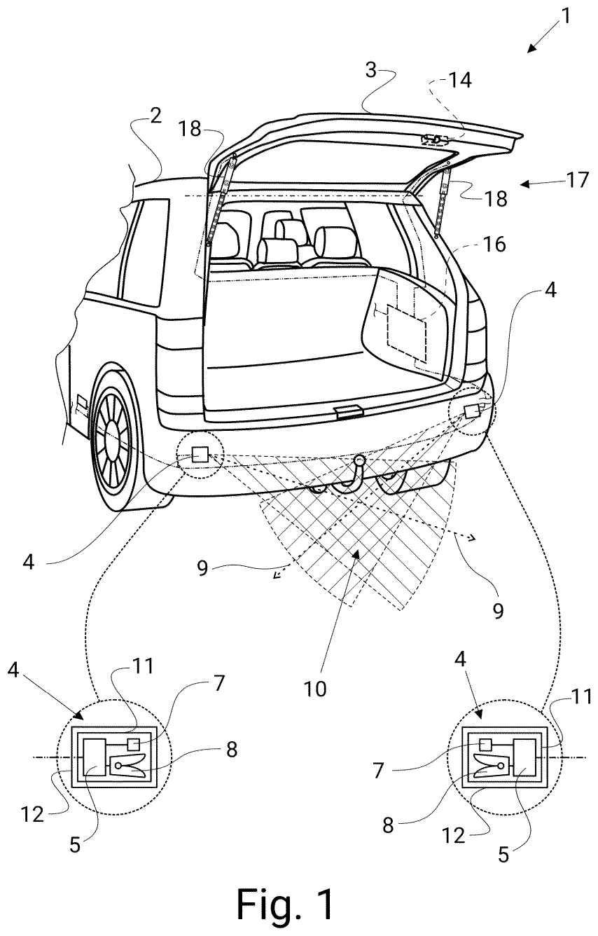

The proposed method relates to the operation of a motorized closure element assembly 1 of a motor vehicle 2. The closure element assembly 1 comprises a closure element 3. Using the illustrated exemplary embodiment, the method will be explained in particular for a closure element 3 designed as a tailgate. However, the statements also apply to other closure elements of the motor vehicle 2, in particular those mentioned in the introduction. The closure element assembly 1 allows a motorized transfer of the closure element 3 from a closed position to the open position shown in FIG. 1. A motorized transfer from an open position to a closed position can also be provided.

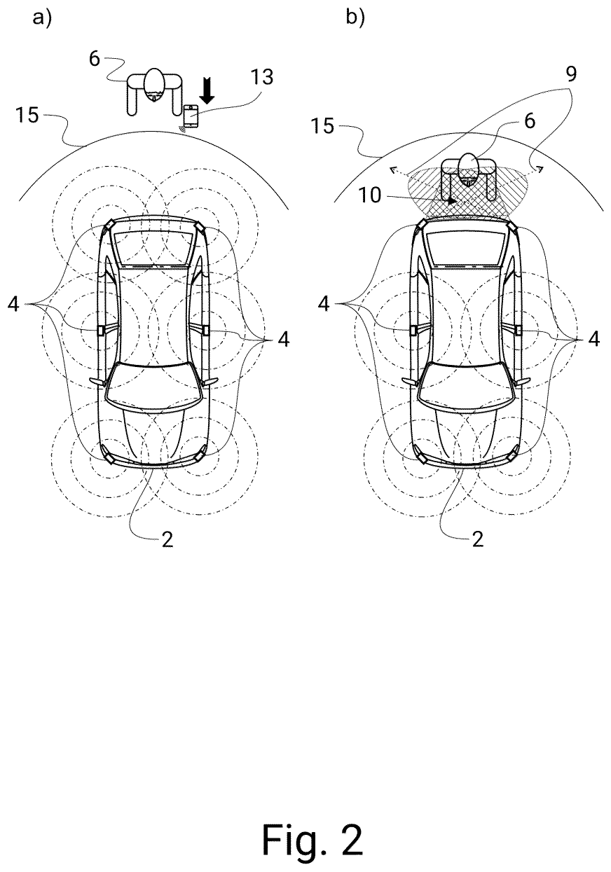

The method is performed using a sensor system having a plurality of UWB modules 4, which are arranged spaced apart from one another on the motor vehicle 2. As shown in FIG. 1, at least two UWB modules 4 are provided, which are arranged here on opposite sides of the closure element 3. In principle, additional UWB modules 4 may be provided on the motor vehicle 2, which in particular allow monitoring of the motor vehicle environment in different directions and in particular along the entire periphery of the motor vehicle 2, which can be further seen in FIG. 2a).

The UWB modules 4 each have a module controller 5, which operates antennas for UWB operation to be explained below. The module controller 5 can act upon the antennas for transmitting UWB signals and register, and in particular evaluate, UWB signals received by the antennas. In various embodiments, the UWB modules 4 are configured for communication in the frequency range from 3.1 GHz to 10.6 GHz. The UWB signals used by the UWB modules 4 can be pulses with a bandwidth of at least 500 MHz, further, in some embodiments, with a duration on the order of nanoseconds. The UWB modules 4 can be designed as integrated modules, wherein antennas and the module controller 5, equipped with a microcontroller, for example, are implemented in one unit.

By means of the UWB modules 4, a localization of an operator 6 approaching the motor vehicle 2 is carried out. The term localization is understood generally to mean that location information of the operator 6 relative to the motor vehicle 2 is determined by means of the UWB modules 4 via the UWB operation. In various embodiments, as part of the localization, distance information and direction information of the operator 6 relative to the motor vehicle 2 can be determined. The implementation of the localization is shown schematically in FIG. 2a).

In the localization, the module controllers 5 operate a respective first antenna 7 of the UWB module 4 with a first directional characteristic for sending and receiving UWB signals. The UWB modules 4 thus each have a first antenna 7, which are used for localization and for determining the location information of the operator 6. The directional characteristic can be understood to mean a spatial distribution of at least one quantitative measure of the transmission and/or reception characteristic, which can be represented, for example, in an antenna diagram.

Upon detection of a predefined switching event related to the operator 6, the UWB modules 4 carry out a gesture recognition procedure, in which the module controllers 5 operate a respective second antenna 8 of the UWB module 4 for sending and receiving UWB radar signals. In addition to the first antenna 7, the UWB modules 4 therefore each have the second antenna 8, which is also operated via the module controller 5. Accordingly, at least partially identical control components are used for the operation of the first antenna 7 and second antenna 8, wherein the module controller 5 in particular has a high-frequency crossover for the selective operation of the first antenna 7 and the second antenna 8. The second antenna 8 is equipped with a second directional characteristic, wherein the second directional characteristic here is configured differently to the first directional characteristic of the first antenna 7. The second directional characteristic has a main direction 9, which can represent a preferred direction of the directional characteristic, in particular the spatial direction with the highest radiated intensity or highest reception sensitivity.

The main directions 9 of the second antennas 8 of the UWB modules 4 are directed at a predefined region of interest 10. The region of interest 10 is a spatial region, which is predefined relative to the motor vehicle 2 and is provided for the execution of the operator gesture to be detected. The implementation of the gesture recognition is shown schematically in FIG. 1 and FIG. 2b). In this case, it may be provided that one of the UWB modules 4 uses the second antenna 8 for transmitting UWB radar signals, while the UWB radar signals reflected from the operator 6 are received by the second antennas 8 of a plurality, here the two UWB modules 4, thereby, for example, enabling a spatial resolution of the radar targets. The UWB radar signals may have the same structure as the UWB signals used for localization.

In the gesture recognition, the UWB radar signals are used to monitor the execution of an operator gesture in region of interest 10. In various embodiments, radar sensor values obtained based on the transmission and reception of the UWB radar signals are checked via predefined operator gesture criteria for the presence of a valid operator gesture. The operator gesture criteria may relate to predetermined characteristics of the operator gesture to be performed, for example, the position, speed, acceleration of a detected radar target or the like. Based on the correspondence existing between the radar sensor values and the characteristics, it can be decided whether the detection will be classified as a valid operator gesture or rejected as invalid. In the presence of a valid operator gesture, the activation of the motorized closure element assembly 1 is triggered for adjusting the closure element 3. In the case of a detection classified as invalid, on the other hand, the closure element assembly 1 is not activated.

Using the directional characteristics of the first antennas 7 and second antennas 8, the UWB operation can be optimally adapted to the requirements of the localization and gesture recognition procedures without the need for additional control technology components. As shown in FIG. 2a), in a some embodiments the first antennas 7 each have an omnidirectional first directional characteristic. With an omni-directional first directional characteristic, the first antennas 7 are essentially undirected and can cover the widest possible detection range for the localization. In various embodiments, the omni-directional first directional characteristic is a spherical characteristic. A spherical characteristic is also understood to include directional characteristics which in practice exhibit an unavoidable deviation from an ideal, isotropic directional characteristic.

The second antennas 8 are designed here as directed antennas with a main direction 9 and may, for example, each have a lobe characteristic, bi-directional characteristic and/or cardioid characteristic as the second directional characteristic. By the alignment of the second antennas 8 it becomes possible to monitor a smaller spatial region and in particular the region of interest 10 with increased performance for the gesture recognition, which again is shown in FIG. 2b).

In various embodiments, it can be provided here that the first antenna 7 is configured as a patch antenna, in which case in particular an approximately spherical characteristic of the first antenna 7 is implemented. The second antenna 8 may be configured, for example, as an Edgefire antenna, in particular a Vivaldi antenna.

In various embodiments, the first antenna 7 and second antenna 8 are generally arranged on a common printed circuit board 11 of the respective UWB module 4, for example via a common arrangement of a patch antenna and Edgefire antenna. As a result, the different directional characteristics of the antennas can be covered with a flat design.

A more compact structure of the UWB modules 4 can be achieved by also arranging the module controller 5 is on the printed circuit board 11.

Altogether, the module controller 5, the first antenna 7 and the second antenna 8 can be arranged in a common module housing 12 of the respective UWB module 4, which can enclose these components in various embodiments. The module housing 12 may have a common radome for the first antenna 7 and the second antenna 8.

It can be further provided here that the main directions 9 of the second antennas 8 are directed toward one another. Starting from the position of the UWB modules 4, the detection ranges of the second antennas 8 approach one another. An overlap region of the detection ranges, for example of the lobe characteristics shown in FIG. 2b), can form the region of interest 10.

In various embodiments, it is provided that the main directions 9 of the second antennas 8 intersect in the predefined region of interest 10, so that a high coverage of the detection ranges is achieved.

In principle, the region of interest 10 may be provided in front of the closure element 3, thus enabling a particularly intuitive gesture control. In the illustration of FIGS. 1 and 2b), the UWB modules 4 are arranged on opposite sides of the closure element 3 and here on the fender, wherein the main directions 9 of the second antennas 8 are at least partially directed toward the center of the closure element 3. Accordingly, a region of interest 10 is formed in front of the closure element 3. In one embodiment, the region of interest 10 may be defined on a control element of the closure element 3, such as a door handle or the like, which is particularly useful in the case of side doors which can be released, for example, via a swiping movement of the hand. In the illustration from FIG. 1, in order to actuate the tailgate the region of interest 10 is defined on the fender on the closure element assembly 1, so that, for example, triggering via a foot movement such as a kicking action can be implemented in a simple manner.

It can be provided that the localization is performed via a UWB communication between at least one of the UWB modules 4 and a mobile device 13 assigned to the operator 6. The mobile device 13 can be configured, for example, as an electronic key, a key fob, portable chip such as a UWB chip, mobile phone, PDA, a wearable or the like. The UWB module 4 and the mobile device 13 are configured in this case to perform a localization on the basis of a bidirectional UWB communication. In particular, for this purpose UWB communication is carried out according to a standard such as IEEE 802.15.4z and runtime information is exchanged between UWB module 4 and mobile device 13, on the basis of which the localization is performed.

The localization can be triggered on detection of the mobile device 13 via further wireless communication, in particular BLE communication or the like. In particular, at least one BLE module, which can be associated with the sensor system, monitors the entry of a mobile device 13 into a detection range when the UWB modules 4 are deactivated, by sending and receiving advertising signals. If a mobile device 13 is detected via the BLE communication, the UWB modules 4 can be activated for the localization.

In principle, it can be provided that the UWB communication and/or BLE communication can be used to perform an authentication of the mobile device 13. For example, one or more actions of the proposed method are carried out only if the UWB communication and/or BLE communication shows that the detected mobile device 13 is already stored as a permissible mobile device 13 for the motor vehicle 2.

In a further embodiment, it is provided that, on an approach of the operator 6 being detected in the localization, the closure element assembly 1 is unlocked. The closure element 3 can be assigned a motor vehicle lock 14, which is set into an unlocked lock state in response to the detected approach. The operator 6 can therefore open the closure element 3, either by executing the operator gesture or by actuating the door handle, by making the approach. In various embodiments, the approach of the operator 6 is deemed to be detected if the localization results in a distance that is less than a predefined first distance between mobile device 13 and motor vehicle 2. The first distance can also be specified as being direction-dependent.

It can further be provided here that the switching event is deemed to be detected if the localization results in a distance that is less than a predetermined second distance 15 between the mobile device 13 and the closure element assembly 1. The second distance 15 may be less than the mentioned first distance for unlocking the closure element assembly 1. The second distance 15 can also be specified as being direction-dependent. Here, the gesture recognition for releasing the tailgate is initiated, for example, when the operator 6 approaches the region of interest 10 on the tailgate sufficiently closely.

The switching event can be linked to additional or alternative conditions. In a further embodiment, it is provided that the switching event is deemed to be detected if the localization results in a predefined approach trajectory to the closure element assembly 1 being maintained. The approach trajectory generally relates to the time course of the position of the operator 6 or the mobile device 13 during the approach. For example, the approach trajectory is used to check whether the operator 6 or the mobile device 13 is approaching the motor vehicle 2 within a predefined motion path and/or at a predefined speed. Incorrect triggering of the gesture recognition, which occurs, for example, when an operator 6 walks past the motor vehicle 2, can thus be avoided.

It can further be provided here that if a valid operator gesture fails to be detected in the gesture recognition, the procedure reverts back to localization of the operator 6 by means of the UWB modules 4. The return to the localization is performed in particular after a predefined period of time has elapsed after the start of the gesture recognition or after the detection of an operator gesture that is classified as invalid. In various embodiments, on returning to the localization, the occurrence of the switching event is checked again based on the localization.

In a further embodiment, the sensor system may comprise a plurality of pairs of UWB modules 4, which are each assigned to one of a plurality of motorized closure element assemblies 1 of the motor vehicle 2 and for which a switching event is predefined in each case. For example, both the tailgate and the side doors in a respective closure element assembly 1 are adjustable by motorized means. The closure element assemblies 1 can be assigned UWB modules 4 positioned in the region of the closure element 3. In principle, more than two UWB modules 4 can also be assigned to a closure element assembly 1. Also, individual UWB modules 4 may be assigned to a plurality of closure element assemblies 1, wherein, for example, individual UWB modules 4 are used for gesture recognition for both the tailgate and for a rear side door.

On the detection of one of the switching events by means of the respectively assigned pair of UWB modules 4 a gesture recognition is performed. The gesture recognition and the triggering of the motorized adjustment made possible as a result are carried out for the respective closure element 3. In FIG. 2b), for example, in addition to the gesture recognition for the tailgate shown, gesture recognition for at least one of the side doors can be provided, which then have a respective region of interest 10 with respective assigned UWB modules 4.

According to a further teaching, a sensor system for a motorized closure element assembly 1 of a motor vehicle 2 is proposed. The sensor system is equipped with a plurality of UWB modules 4, which are arrangeable spaced apart from each other on the motor vehicle 2 and have a module controller 5 in each case. The UWB modules 4 are designed for localization of an operator 6 approaching the motor vehicle 2, in which the module controllers 5 operate a respective first antenna 7 of the UWB module 4 with a first directional characteristic for sending and receiving UWB signals. On detection of a predefined switching event related to the operator 6, the UWB modules 4 perform a gesture recognition in which the module controllers 5 operate a respective second antenna 8 of the UWB module 4 with a second directional characteristic having a main direction 9 for sending and receiving UWB radar signals, wherein in the assembled state of the sensor system the main directions 9 are each directed at a predefined region of interest 10 for executing the operator gesture. Reference may therefore be made in this respect to all the comments in relation to the proposed method.

It can further be provided here that the sensor system has a control assembly, which monitors the execution of an operator gesture in the region of interest 10 in the gesture recognition based on the UWB radar signals and, in the presence of a valid operator gesture, initiates the activation of the motorized closure element assembly 1.

The control assembly can be implemented via at least one of the module controllers 5 and/or, as shown in FIG. 1, via a control unit 16 such as an opening control device or door control device. The control assembly can implement further functions with respect to the closure element assembly 1, for example, the unlocking and/or opening of a motor vehicle lock 14 assigned to the closure element 3.

According to various embodiments, a closure element assembly 1 for a motor vehicle 2, the closure element assembly 1 comprising a closure element 3, a drive assembly 17 assigned to the closure element 3 having at least one drive 18 for motorized adjustment of the closure element 3, and a sensor system having a plurality of UWB modules 4 is provided. The closure element assembly 1 is configured to carry out the proposed method.

Reference may therefore be made to all the comments in relation to the proposed method and the proposed sensor system.

1. A method for operating a motorized closure element assembly of a motor vehicle having a closure element, using a sensor system having a plurality of UWB modules which are arranged spaced apart from each other on the motor vehicle and have a module controller in each case,
wherein the UWB modules are used to carry out a localization of an operator approaching the motor vehicle, in which the module controllers operate a respective first antenna of the UWB module with a first directional characteristic for sending and receiving UWB signals,
wherein, on detection of a predefined switching event related to the operator, a gesture recognition is performed by means of the UWB modules, in which the module controllers operate a respective second antenna of the UWB module with a second directional characteristic having a main direction for sending and receiving UWB radar signals, wherein the main directions are directed at a predefined region of interest for executing the operator gesture,
wherein in the gesture recognition, the execution of an operator gesture in the region of interest is monitored using the UWB radar signals and, in the presence of a valid operator gesture, activation of the motorized closure element assembly to adjust the closure element is initiated.

2. The method as claimed in claim 1, wherein the first antennas each have an omnidirectional first directional characteristic, and/or in that the second antennas each have a lobe characteristic, a bidirectional characteristic and/or cardioid characteristic as the second directional characteristic.

3. The method as claimed in claim 1, wherein the first antenna is designed as a patch antenna and/or the second antenna is designed as an Edgefire antenna.

4. The method as claimed in claim 1, wherein the module controller, the first antenna and the second antenna are arranged in a common module housing of the respective UWB module.

5. The method as claimed in claim 1, wherein the main directions of the second antennas are directed toward one another.

6. The method as claimed in claim 1, wherein the localization is performed via a UWB communication between at least one of the UWB modules and a mobile device assigned to the operator.

7. The method as claimed in claim 1, wherein in response to an approach of the operator being detected in the localization, the closure element assembly is unlocked.

8. The method as claimed in claim 1, wherein the switching event is deemed to be detected if the localization results in a distance that is less than a predetermined second distance between the mobile device and the closure element assembly and/or a predefined approach trajectory to the closure element assembly being maintained.

9. The method as claimed in claim 1, wherein if a valid operator gesture fails to be detected in the gesture recognition, the procedure reverts back to localization of the operator by the UWB modules.

10. The method as claimed in claim 1, wherein the sensor system comprises a plurality of pairs of UWB modules, which are each assigned to one of a plurality of motorized closure element assemblies of the motor vehicle and for each of which a switching event is predefined, and that gesture recognition is performed on detection of one of the switching events by the respectively assigned pair of UWB modules.

11. A sensor system for a motorized closure element assembly of a motor vehicle, wherein the sensor system is equipped with a plurality of UWB modules which are arranged spaced apart from each other on the motor vehicle and have a module controller in each case,
wherein the UWB modules are designed for localization of an operator approaching the motor vehicle, in which the module controllers operate a respective first antenna of the UWB module with a first directional characteristic for sending and receiving UWB signals,
wherein on detection of a predefined switching event related to the operator, the UWB modules perform a gesture recognition in which the module controllers operate a respective second antenna of the UWB module with a second directional characteristic having a main direction for sending and receiving UWB radar signals, wherein in the assembled state of the sensor system the main directions are directed at a predefined region of interest for executing the operator gesture.

12. The sensor system as claimed in claim 11, wherein the sensor system has a control assembly, which monitors the execution of an operator gesture in the region of interest in the gesture recognition based on the UWB radar signals and, in the presence of a valid operator gesture, initiates the activation of the motorized closure element assembly.

13. A closure element assembly for a motor vehicle, the closure element assembly comprising a closure element, a drive assembly associated with the closure element having at least one drive for the motorized adjustment of the closure element, and a sensor system having a plurality of UWB modules, wherein the closure element assembly is designed for carrying out the method as claimed in claim 1.

14. The method as claimed in claim 3, wherein the first antenna and second antenna are arranged on a common printed circuit board of the respective UWB module.

15. The method as claimed in claim 14, wherein the module controller is also arranged on the printed circuit board.

16. The method as claimed in claim 5, wherein the main directions of the second antennas intersect in the predetermined region of interest.

17. The method as claimed in claim 16, wherein the region of interest is predefined in front of the closure element.

18. The method as claimed in claim 6, wherein the localization is triggered on detection of the mobile device via a further wireless communication.

19. The method as claimed in claim 18, wherein the UWB communication and/or the further wireless communication is used to perform authentication of the mobile device.

20. The method as claimed in claim 7, wherein the approach of the operator is deemed to be detected if the localization results in a distance that is less than a predefined first distance between the mobile device and the motor vehicle.
